(19) United States
(12) Patent Application Publication
(10) Pub. No.: US 2010/0284884 A1
(43) Pub. Date: Nov. 11, 2010

(54) METHOD FOR MAKING COLLOIDAL SILICA PARTICLES

(76) Inventor: James Neil Pryor, West Friendship, MD (US)

Correspondence Address: W.R. GRACE & CO.-CONN., 7500 GRACE DRIVE, COLUMBIA, MD, 21044, US

(21) Appl. No.: 12/810,974

(22) PCT Filed: Dec. 4, 2008
(86) PCT No.: PCT/US08/13358

§ 371 Date: Jun. 28, 2010

(30) Foreign Application Priority Data
Dec. 27, 2007 (US) 61/009924

(51) Int. Cl. C01B 33/141; C01B 13/14

(52) U.S. Cl. 423/335; 423/592.1; 977/773

(57) ABSTRACT

Methods of making colloidal metal oxide particles and compositions containing colloidal metal oxide particles are disclosed.

### FIELD OF THE INVENTION

The present invention is directed to methods of making colloidal metal oxide particles.

### BACKGROUND OF THE INVENTION

Efforts continue in the art to form colloidal metal oxide particles in an energy efficient manner.

There is a need in the art for improved processes of forming colloidal metal oxide particles in an energy efficient manner while optimizing apparatus utilization.

### SUMMARY OF THE INVENTION

The present invention provides new methods of forming colloidal metal oxide particles. The disclosed methods of forming colloidal metal oxide particles enable the formation of colloidal metal oxide particles under near optimum process conditions so as to form the colloidal metal oxide particles in a very efficient manner. Further, the disclosed methods of forming colloidal metal oxide particles enable optimum utilization of reaction vessels due to decreased reaction periods needed to form colloidal metal oxide particles.

The disclosed methods of forming colloidal metal oxide particles comprise a step of adding one or more reactants to a reaction vessel, wherein the step of adding one or more reactants takes into account various in situ reaction conditions including, but not limited to, at least one of (i) a particle nucleation rate within a reaction vessel, (ii) a metal oxide deposition rate onto existing metal oxide particles (e.g., seed metal oxide particles and/or nucleated metal oxide particles) within the reaction vessel, and/or (iii) growth of metal oxide particles (e.g., seed metal oxide particles and/or nucleated metal oxide particles) within the reaction vessel.

In one exemplary embodiment, a method of making colloidal metal oxide particles comprises the step of adding reactive metal oxide to a reaction vessel at a metal oxide mass addition rate that is based on a mathematical model that takes into account at least one of (i) a particle nucleation rate, (ii) a metal oxide deposition rate onto existing metal oxide particles, and/or (iii) growth of metal oxide particles in the reaction vessel, wherein the metal oxide mass addition rate increases as a function of reaction time. In a further embodiment the addition rate is greater than 10.0 grams of reactive metal oxide per 1000 square meters (m²) of total particle surface area per hour (g/1000 m²-hr) during at least a portion of a reaction period. In an even further exemplary embodiment, a method of making colloidal metal oxide particles according to the present invention comprises the step of adding reactive metal oxide to a reaction vessel at a metal oxide mass addition rate according to a mathematical model that provides an optimum metal oxide mass addition rate, q, as represented by the formula:

q=(3mₒGᵣ/Dₚₒ³)(Dₚₒ+Gᵣt)²

wherein:
(a) mₒ represents a mass of metal oxide particles in the reaction vessel as measured in grams (g);
(b) Gᵣ represents a metal oxide particle growth rate of the metal oxide particles in the reaction vessel as determined by an increase in particle diameter and as measured in nanometers per hour (nm/hr);
(c) Dₚₒ represents an average metal oxide particle diameter as measured in nanometers (nm); and
(d) t represents time in hours (hr).

The disclosed methods of making colloidal metal oxide particles may comprise a step of forming nucleated metal oxide particles and/or a step of growing metal oxide seed particles. In one exemplary embodiment, the method of making colloidal metal oxide particles comprises the step of adding one or more reactants to a reaction vessel (i) containing water and (ii) being substantially free of any seed metal oxide particles, wherein the one or more reactants are capable of forming nucleated metal oxide particles; forming nucleated metal oxide particles within the reaction vessel; and growing the nucleated metal oxide particles within the reaction vessel so as to form colloidal metal oxide particles, wherein the growing step comprises increasing a feed rate of the one or more reactants over a reaction period.

The disclosed methods of making colloidal metal oxide particles enable the production of colloidal metal oxide particles in an energy efficient manner with a reaction period significantly less than conventional reaction periods for forming colloidal metal oxide particles. In one exemplary embodiment, the method of making colloidal metal oxide particles comprises the step of adding reactive metal oxide to a reaction vessel at a metal oxide mass addition rate over a reaction period so as to form colloidal metal oxide particles having an average final particle diameter ranging from about 10 nm to about 200 nm, wherein the reaction period is as much as 50% shorter than a similar reaction period using conventional techniques (e.g., a constant reactive metal oxide feed rate). For example, using the present method, colloidal metal oxide particles having an average particle diameter in the range of 20-30 nm may be formed in a reaction period of about 21-28 minutes, while conventional methods of forming similarly sized colloidal metal oxide particles require reaction periods of at least 30 minutes, typically, from about 31 to 40 minutes.

In another exemplary embodiment, the method of making colloidal metal oxide particles comprises the step of adding reactive metal oxide to a reaction vessel at a metal oxide mass addition rate over a reaction period so as to form colloidal metal oxide particles having an average final particle diameter ranges from about 20 nm to about 200 nm, the metal oxide mass addition rate increasing at least once during the reaction period. The increase in the metal oxide mass addition rate may, for example, be a single step increase or multiple step increases.

The present invention is further directed to methods of using colloidal metal oxide particles. In one exemplary method of using colloidal metal oxide particles, the method comprises applying a colloidal metal oxide particle composition onto a substrate; and drying the colloidal metal oxide particle composition so as to form a coating on the substrate.

These and other features and advantages of the present invention will become apparent after a review of the following detailed description of the disclosed embodiments and the appended claims.

### BRIEF DESCRIPTION OF THE FIGURES

FIG. 1 graphically depicts (i) nucleation rate of reactive metal oxide and (ii) deposition rate of reactive metal oxide onto existing particles as the concentration of reactive metal oxide changes;

FIG. 2 graphically depicts conditions that favor (i) deposition rate of reactive metal oxide onto existing particles, (ii) nucleation of new colloidal metal oxide particles and (iii) both (i) and (ii) as the concentration of reactive metal oxide changes;

FIG. 3 graphically depicts the reduction in reaction time needed to form colloidal metal oxide particles having an average particle diameter of 22 nm using (i) the optimized reactive metal oxide feed rate of the present invention and (ii) a constant reactive metal oxide feed rate used in conventional processes;

FIG. 4 graphically depicts step-wise addition of reactive metal oxide using optimized methods of the present invention so as to closely follow an optimal feed rate; and

FIG. 5 graphically depicts particle size and surface area of colloidal silica particles formed via the optimized methods of the present invention versus colloidal silica particles formed via conventional methods (i.e., a constant reactive silica feed rate).

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “an oxide” includes a plurality of such oxides and reference to “oxide” includes reference to one or more oxides and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, “metal oxides” is defined as binary oxygen compounds where the metal is the cation and the oxide is the anion. The metals may also include metalloids. Metals include those elements on the left of the diagonal line drawn from boron to polonium on the periodic table. Metalloids or semi-metals include those elements that are on this line. Examples of metal oxides include silica, alumina, titania, zirconia, etc., and mixtures thereof.

The present invention is directed to methods of making colloidal metal oxide particles. The present invention is further directed to colloidal metal oxide particles, compositions comprising colloidal metal oxide particles, as well as methods of using colloidal metal oxide particles. A description of exemplary colloidal metal oxide particles, methods of making colloidal metal oxide particles, and methods of using colloidal metal oxide particles is provided below.

### I. Methods of Making Colloidal Metal Oxide Particles

The present invention is directed to methods of making colloidal metal oxide particles. Raw materials used to form the colloidal metal oxide particles of the present invention, as well as method steps for forming the colloidal metal oxide particles of the present invention are discussed below.

A. Raw Materials

The disclosed methods of making colloidal metal oxide particles may utilize one or more of the following raw materials for making colloidal silica particles, but alternative raw materials may be utilized to form other types of colloidal metal oxide materials, such as colloidal alumina particles, colloidal titania particles, colloidal zirconia particles, etc., and combinations thereof.

1. Silicates

The methods of making colloidal silica particles may utilize one or more silicon-containing raw materials. Suitable silicon-containing raw materials include, but are not limited to, silicates such as alkali metal silicates. Desirably, one or more alkali metal silicates are used to form colloidal silica particles. Suitable alkali metal silicates include, but are not limited to, sodium silicate, potassium silicate, calcium silicate, lithium silicate, magnesium silicate, and combinations thereof.

Suitable commercially available silicates include, but are not limited to, sodium and potassium silicates commercially available from a number of sources including PQ Corporation (Valley Forge, Pa.) and Zaclon, Inc. (Cleveland, Ohio).

2. Ion-Exchange Resins

Any single silicate or combination of silicates may be reacted with one or more cation exchange resins to form colloidal silica particles in the disclosed methods. Suitable cation exchange resins for use in the present invention include, but are not limited to, strong acid cation (SAC) resins, weak acid cation (WAC) resins, and combinations thereof.

Suitable commercially available cation exchange resins include, but are not limited to, cation exchange resins commercially available from a number of sources including Purolite Corporation (Bala Cynwyd, Pa.) such as those sold under the PUROLITE® trade designation, and Dow Chemical (Midland, Mich.) such as those sold under the DOWEX® trade designation.

Typically, one or more cation exchange resins are added to a reaction vessel at a resin addition rate so as to maintain the pH of the reaction vessel between about 8.0 and about 10.0, desirably, between about 9.2 and about 9.6.

3. Seed Metal Oxide Particles

In some embodiments of the present invention, seed metal oxide particles are utilized as a starting raw material. In these embodiments, seed colloidal metal oxide particles from a number of suppliers may be used. Suitable seed colloidal metal oxide particles for use in the present invention include, but are not limited to, seed colloidal metal oxide particles, such as colloidal silica particles commercially available from Nissan Chemical America Corporation (Houston, Tex.) and Eka Chemicals, Inc. (Marietta, Ga.).

B. Process Steps

The disclosed methods of making colloidal metal oxide particles comprise a number of steps as discussed below.

1. Preparation of Reaction Vessel

The disclosed methods of making colloidal metal oxide particles enable the production of colloidal metal oxide particles in an energy efficient manner with a reaction period significantly less than conventional reaction periods for forming colloidal metal oxide particles. In one exemplary embodiment, the method of making colloidal metal oxide particles comprises the step of adding one or more reactants to a reaction vessel (i) containing water and (ii) being substantially free of any seed metal oxide particles, wherein the one or more reactants are capable of forming nucleated metal oxide particles. In this embodiment, the step of preparing a reaction vessel simply comprises adding a desired amount of deionized (DI) water to the reaction vessel.

In other embodiments, the method of making colloidal metal oxide particles comprises the step of adding one or more reactants to a reaction vessel containing (i) deionized (DI) water and (ii) seed metal oxide particles, wherein the one or more reactants are capable of forming nucleated metal oxide particles and/or growing the seed metal oxide particles. In this embodiment, the step of preparing a reaction vessel comprises adding (i) a desired amount of deionized (DI) water and (ii) a desired amount of seed metal oxide particles to the reaction vessel. When utilized, the seed metal oxide particles typically have an initial average particle size (i.e., largest dimension) ranging from about 5 nm to about 15 nm.

2. Addition of Reactive Metal Oxide

The disclosed methods of forming colloidal metal oxide particles comprise a step of adding one or more of the above-described reactants to a reaction vessel, wherein the step of adding the one or more reactants takes into account various in situ reaction conditions including, but not limited to, at least one of (i) a particle nucleation rate within the reaction vessel, (ii) a metal oxide deposition rate onto existing metal oxide particles (e.g., seed metal oxide particles and/or nucleated metal oxide particles) within the reaction vessel, and/or (iii) growth of metal oxide particles (e.g., seed metal oxide particles and/or nucleated metal oxide particles) within the reaction vessel. The disclosed methods of forming colloidal metal oxide particles balance the feed rate of reactants against the deposition rate of reactive metal oxide onto existing metal oxide particles so as to control the extent of supersaturation of reactive metal oxide in the solution phase.

In one exemplary embodiment, a method of making colloidal metal oxide particles comprises the step of adding reactive metal oxide to a reaction vessel at a metal oxide mass addition rate that is based on a mathematical model that takes into account at least one of (i) a particle nucleation rate, (ii) a metal oxide deposition rate onto existing metal oxide particles, and/or (iii) growth of metal oxide particles in the reaction vessel, wherein the metal oxide mass addition rate increases as a function of reaction time. In a further embodiment, the addition rate is greater than 10.0 grams of reactive metal oxide per 1000 square meters (m²) of total particle surface area per hour (g/1000 m²-hr) during at least a portion of a reaction period. In an even further exemplary embodiment, a method of making colloidal metal oxide particles according to the present invention comprises the step of adding reactive metal oxide to a reaction vessel at a metal oxide mass addition rate according to a mathematical model that provides an optimum metal oxide mass addition rate, q, as represented by the formula:

q=(3mₒGᵣ/Dₚₒ³)(Dₚₒ+Gᵣt)²

wherein:
(a) mₒ represents a mass of metal oxide particles in the reaction vessel as measured in grams (g);
(b) Gᵣ represents a metal oxide particle growth rate of the metal oxide particles in the reaction vessel as determined by an increase in particle diameter and as measured in nanometers per hour (nm/hr);
(c) Dₚₒ represents an average metal oxide particle diameter as measured in nanometers (nm); and
(d) t represents time in hours (hr).

In some embodiments, Gᵣ ranges from about 10 to about 50 nm/hr, and q ranges from about 10.6 to about 52.8 g/1000 m²-hr during at least a portion of the reaction period. In other embodiments, Gᵣ ranges from about 20 to about 40 nm/hr, and q ranges from about 21.1 to about 42.3 g/1000 m²-hr during at least a portion of the reaction period.

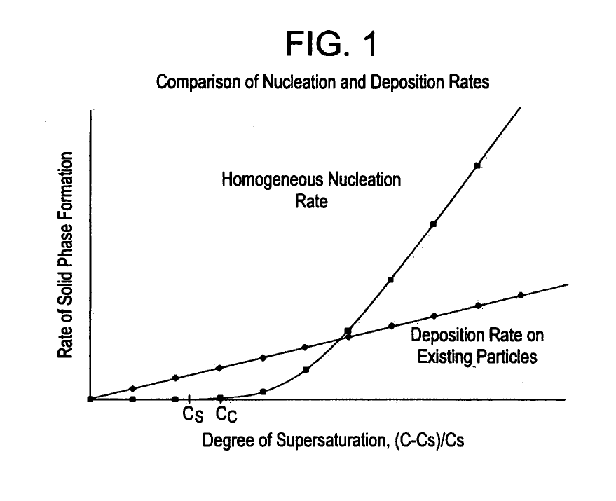

FIG. 1 graphically depicts a plot of (i) nucleation rate, R_{N}, of reactive metal oxide and (ii) deposition rate, D_{R}, of reactive metal oxide onto existing particles as the concentration of reactive metal oxide changes. As shown in FIG. 1, nucleation does not take place until (i) the concentration of reactive metal oxide exceeds a concentration at saturation, Cₛ, and (ii) reaches a critical level of supersaturation identified as C_{c}. At this point, nucleation proceeds at an exponential rate, while the deposition rate continues along a linear path as the concentration of reactive metal oxide increases.

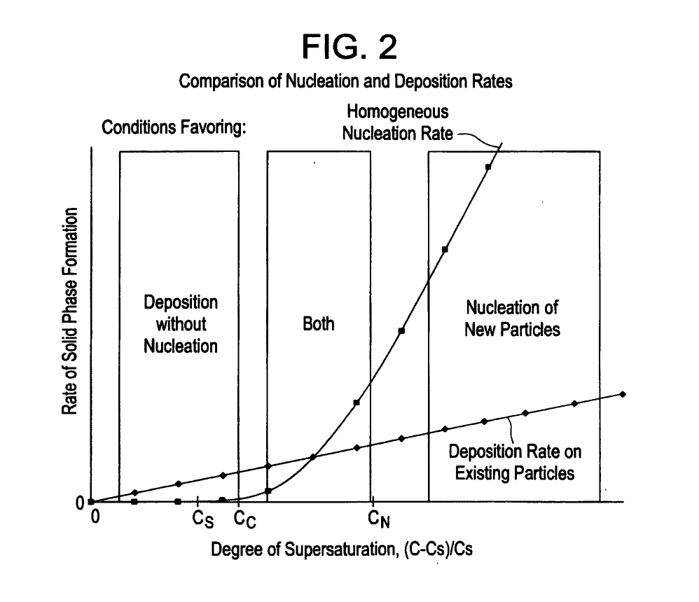

FIG. 2 graphically depicts process conditions that favor (i) deposition rate of reactive metal oxide onto existing particles (i.e., at concentrations of reactive metal oxide less than C_{c}), (ii) nucleation of new colloidal metal oxide particles (i.e., at concentrations of reactive metal oxide above C_{c}) and (iii) both (i) and (ii) (i.e., at concentrations of reactive metal oxide above C_{c} and below a concentration C_{N} shown in FIG. 2) as the concentration of reactive metal oxide increases. When the concentration of reactive metal oxide increases above C_{N} shown in FIG. 2, process conditions significantly favor nucleation of new metal oxide particles over deposition of metal oxide onto existing particles.

3. Completion of Particle Formation Step

Once a desired metal oxide particle size has been reached, the addition of reactants to the reaction vessel is stopped, and an amount of deionized water is added to the reaction vessel in order to quench the reaction.

4. Filtering Step

Following the quenching step, a filtering step (e.g., an ultrafiltration step) may be employed to remove unwanted salts resulting from the reaction of one or more cation exchange resins with one or more metal oxide raw materials.

C. Process Benefits

The disclosed methods of making colloidal metal oxide particles enable the production of colloidal metal oxide particles while optimizing the utilization of reactor time and energy. In some exemplary embodiments, the method of making colloidal metal oxide particles enables the production of colloidal metal oxide particles having an average final particle diameter ranging from about 30 nm to about 200 nm in a reaction period that represents a 50% reduction in reaction period needed for making the same colloidal metal oxide particles using conventional methods.

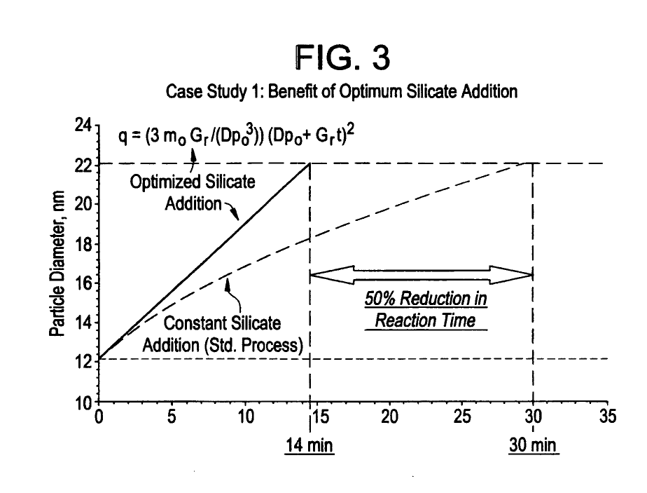

FIG. 3 graphically depicts the reduction in reaction time needed to form colloidal silica particles having an average particle diameter of 22 nm using (i) the optimized reactive silica feed rate of the present invention, and (ii) a constant reactive silica feed rate used in conventional processes.

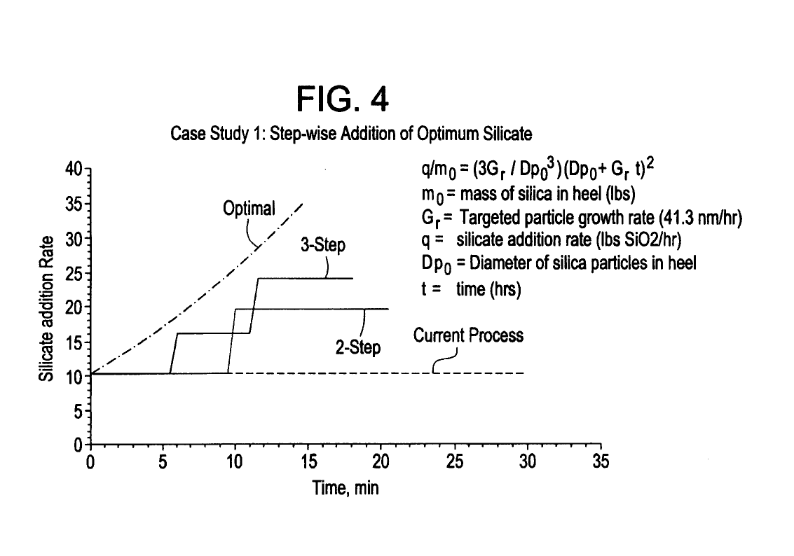

FIG. 4 graphically depicts step-wise addition of reactive silica using optimized methods of the present invention so as to closely follow an optimal feed rate. As shown in FIG. 4, the disclosed methods of making colloidal silica particles may comprise one or more stepwise increases in the reactive silica feed rate during a given reaction period. Although only two-step or three-step methods are shown in FIG. 4, any number of step increases in the reactive silica feed rate may be used in the present invention to closely follow an optimal feed rate depicted by the “optimal” line shown in FIG. 4.

### II. Resulting Colloidal Metal Oxide Particles

The colloidal metal oxide particles formed in the above-described methods of the present invention have a physical structure and properties similar to colloidal metal oxide particles formed in conventional methods of forming colloidal metal oxide particles as described below.

A. Metal Oxide Particle Dimensions

The colloidal metal oxide particles of the present invention have a spherical particle shape with an average largest particle dimension (i.e., a largest diameter dimension). Typically, the colloidal metal oxide particles of the present invention have an average largest particle dimension of less than about 700 μm, more typically, less than about 100 μm. In one desired embodiment of the present invention, the colloidal metal oxide particles have an average largest particle dimension of from about 10.0 to about 100 μm, more desirably, from about 10.0 to about 30 μm.

The colloidal metal oxide particles of the present invention typically have an aspect ratio of less than about 1.4 as measured, for example, using Transmission Electron Microscopy (TEM) techniques. As used herein, the term “aspect ratio” is used to describe the ratio between (i) the average largest particle dimension of the colloidal metal oxide particles and (ii) the average largest cross-sectional particle dimension of the colloidal metal oxide particles, wherein the cross-sectional particle dimension is substantially perpendicular to the largest particle dimension of the colloidal metal oxide particle. In some embodiments of the present invention, the colloidal metal oxide particles have an aspect ratio of less than about 1.3 (or less than about 1.2, or less than about 1.1, or less than about 1.05). Typically, the colloidal metal oxide particles have an aspect ratio of from about 1.0 to about 1.2.

B. Metal Oxide Particle Surface Area

The colloidal metal oxide particles of the present invention have an average surface area similar to colloidal metal oxide particles formed from conventional methods. Typically, the colloidal metal oxide particles of the present invention have an average surface area ranging from about 90 m²/g to about 180 m²/g. Desirably, the colloidal metal oxide particles of the present invention have an average surface area ranging from about 100 m²/g to about 160 m²/g, more desirably, from about 110 m²/g to about 150 m²/g.

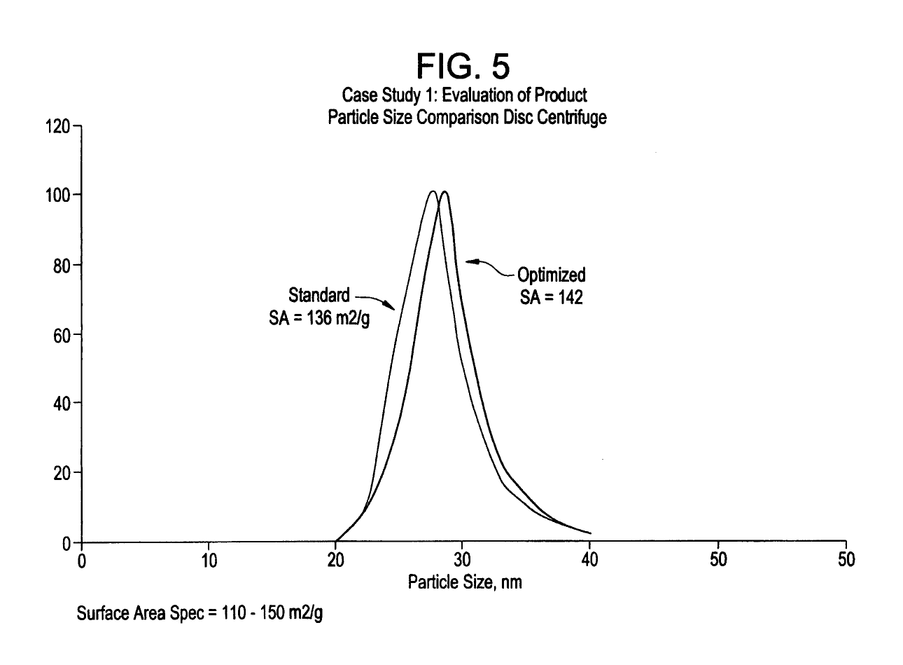

FIG. 5 graphically compares colloidal metal oxide particles, in this case colloidal silica particles, formed by the optimized process of the present invention with colloidal silica particles formed from conventional methods (i.e., a non-optimized process, namely, a constant metal oxide raw material feed rate). As shown in FIG. 5, colloidal silica particles formed from conventional methods had an average particle size of about 27.6 nm and an average particle surface area of about 136 m²/g, while colloidal silica particles formed by the optimized process of the present invention had an average particle size of about 28.7 nm and an average particle surface area of about 142 m²/g.

As shown in FIG. 5, colloidal metal oxide (e.g., silica) particles formed by the optimized process of the present invention can produce substantially similar colloidal metal oxide particles as formed from conventional methods. However, as discussed above, the colloidal metal oxide particles formed by the optimized process of the present invention can be produced in a much more efficient manner utilizing up to 50% less reactor time and process energy.

### III. Methods of Using Metal Oxide Particles

The present invention is further directed to methods of using the colloidal metal oxide particles formed in the above-described methods. In one exemplary method of using colloidal metal oxide particles, the method comprises applying a colloidal metal oxide particle composition onto a substrate; and drying the colloidal metal oxide particle composition so as to form a coating on the substrate. Suitable substrates include, but are not limited to, paper, polymeric film, polymeric foam, glass, metal, ceramics, and fabrics.

In other exemplary embodiments, the method of using colloidal metal oxide particles comprises utilizing the colloidal metal oxide particles as an abrasive/polishing composition for micro-electronics or other articles. In other exemplary embodiments, the method of using colloidal metal oxide particles comprises utilizing the colloidal metal oxide particles as an additive in paints to improve the mechanical properties of a dried paint film.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Preparation of Colloidal Silica Particles Using Seed Silica Particles and an Optimized Silicate Addition Rate

28.4 kilograms (kg) (62.6 pounds (Ib)) of deionized (DI) water were added to a 113.5 liter (I) (30 gallon (gal)) heated, agitated vessel to which 4.9 kg (10.9 lb) of a 40 wt % solids suspension of 12 nm colloidal silica material were added as a seed material. While agitating, the mixture was heated and maintained within the temperature range of 90-96° C. Sodium silicate (29 wt % SiO₂, 9 wt % Na₂O) and a strong acid ion-exchange resin were then simultaneously added to the vessel at an initial silicate addition rate equivalent to 167.8 grams (g) SiO₂/min (0.37 lb SiO₂/min). After 10 minutes, the silicate addition rate was increased to 317.5 g SiO₂/min (0.70 lb SiO₂/min) and maintained at this higher rate for an additional 11 minutes.

Throughout the process, the resin addition rate was controlled to maintain the pH of the vessel between 9.2 and 9.6. After 21 minutes of silicate addition, both additions were stopped and the reaction quenched by the addition of DI water.

The resulting product was determined to have a particle size of 22+2 nm with minimal indication of additional nucleation of small particles.

### Comparative Example 1

### Preparation of Colloidal Silica Particles Using Seed Silica Particles and a Constant Silicate Feed Rate

The procedure in Example 1 was repeated except the silicate addition rate equivalent to 167.8 grams (g) SiO₂/min (0.37 lb SiO₂/min) was maintained throughout the process. The resin addition rate was controlled to maintain the pH of the vessel between 9.2 and 9.6. This process was continued for 31 minutes after which additions of silicate and ion-exchange resin were stopped and the growth reaction was quenched by addition of DI water.

The resulting product was determined to have a particle size of 22+2 nm.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

1. A method of making colloidal metal oxide particles, said method comprising the step of:
(a) adding reactive metal oxide to a reaction vessel at a metal oxide mass addition rate that is based on a mathematical model that takes into account (i) a particle nucleation rate, (ii) a metal oxide deposition rate onto existing metal oxide particles, and (iii) growth of metal oxide particles in the reaction vessel, the metal oxide mass addition rate increasing as a function of reaction time.

2. The method of claim 1, wherein the mathematical model provides that an optimum metal oxide mass addition rate, q, is represented by the formula:
q=(3mₒGᵣ/Dₚₒ³)(Dₚₒ+Gᵣt)²
wherein:
(a) mₒ, represents a mass of metal oxide particles in the reaction vessel as measured in grams (g);
(b) Gᵣ represents metal oxide particle growth rate of the silica particles in the reaction vessel as determined by an increase in particle diameter and as measured in nanometers per hour (nm/hr);
(c) Dₚₒ represents an average silica particle diameter as measured in nanometers (nm); and
(d) t represents time in hours (hr).

3. The method of claim 2, wherein Gᵣ ranges from about 10 to about 50 nm/hr, and q ranges from about 10.6 to about 52.8 g/1000 m²-hr during at least a portion of the reaction period.

4. The method of claim 2 wherein Gᵣ ranges from about 20 to about 40 nm/hr, and q ranges from about 21.1 to about 42.3 g/1000 m²-hr during at least a portion of the reaction period.

5. The method of claim 1, wherein the metal oxide mass addition rate is greater than 10.0 grams of reactive metal oxide per 1000 square meters (m²) of total particle surface area per hour (g/1000 m²-hr) during at least a portion of a reaction period.

6. The method of claim 1, wherein the step of adding reactive metal oxide comprises one or more stepwise increases in the metal oxide mass addition rate during the reaction period.

7. The method of claim 1, further comprising the step of:
(a) introducing seed metal oxide particles into the reaction vessel prior to the step of adding reactive metal oxide.

8. The method of claim 7, wherein the seed metal oxide particles have an initial average particle size ranging from about 5 nm to about 15 nm.

9. The method of claim 1, further comprising the step of:
(a) forming nucleated metal oxide particles in the reaction vessel as a result of the step of adding reactive metal oxide to the reaction vessel.

10. The method of claim 9, further comprising the step of:
(a) initially adding an aqueous solution to the reaction vessel prior to the step of adding reactive metal oxide, the aqueous solution being substantially free of metal oxide.

11. (canceled)

12. The method of claim 11, further comprising one or more of the following steps:
(a) quenching a reaction between one or more silicates and one or more ion exchange resins with a sufficient amount of water.

13. The method of claim 1, wherein the reactive period represents at least a 50% reduction in reaction time when compared to a method of forming metal oxide particles in which the metal oxide mass addition rate is constant and below 10.0 g/1000 m²-hr.

14. (canceled)

15. (canceled)

16. (canceled)

17. (canceled)

18. (canceled)

19. (canceled)

20. (canceled)

21. (canceled)

22. A method of making colloidal metal oxide particles comprising: adding reactive metal oxide to a reaction vessel at a metal oxide mass addition rate according to a mathematical model provides that an optimum metal oxide mass addition rate, q, is represented by the formula:
q=(3mₒGᵣ/Dₚₒ³)(Dₚₒ+Gᵣt)²
wherein:
(a) mₒ represents a mass of metal oxide particles in the reaction vessel as measured in grams (g);
(b) Gᵣ represents a metal oxide particle growth rate of the metal oxide particles in the reaction vessel as determined by an increase in particle diameter and as measured in nanometers per hour (nm/hr);
(c) Dₚₒ represents an average metal oxide particle diameter as measured in nanometers (nm); and
(d) t represents time in hours (hr).

23. A method of making colloidal silica particles, said method comprising the step of:
(a) adding reactive silica to a reaction vessel at a silica mass addition rate that is based on a mathematical model that takes into account (i) a particle nucleation rate, (ii) a silica deposition rate onto existing silica particles, and (iii) growth of silica particles in the reaction vessel, the silica mass addition rate increasing as a function of reaction time and being greater than 10.0 grams of reactive silica per 1000 square meters (m²) of total particle surface area per hour (g/1000 m²-hr) during at least a portion of a reaction period.

24. The method of claim 23, wherein the mathematical model provides that an optimum silica mass addition rate, q, is represented by the formula:
q=(3mₒGᵣ/Dₚₒ³)(Dₚₒ+Gᵣt)²
wherein:
(a) mₒ represents a mass of silica particles in the reaction vessel as measured in grams (g);
(b) Gᵣ represents a silica particle growth rate of the silica particles in the reaction vessel as determined by an increase in particle diameter and as measured in nanometers per hour (nm/hr);
(c) Dₚₒ represents an average silica particle diameter as measured in nanometers (nm); and
(d) t represents time in hours (hr).

25. The method of claim 24, wherein Gᵣ ranges from about 10 to about 50 nm/hr, and q ranges from about 10.6 to about 52.8 g/1000 m²-hr during at least a portion of the reaction period.

26. The method of claim 24, wherein Gᵣ ranges from about 20 to about 40 nm/hr, and q ranges from about 21.1 to about 42.3 g/1000 m²-hr during at least a portion of the reaction period.

27. The method of claim 23, wherein the step of adding reactive silica comprises one or more stepwise increases in the silica mass addition rate during the reaction period.

28. The method of claim 23, further comprising the step of:
(a) introducing seed silica particles into the reaction vessel prior to the step of adding reactive silica.

29. The method of claim 28, wherein the seed silica particles have an initial average particle size ranging from about 5 nm to about 15 nm.

30. The method of claim 23, further comprising the step of:
(a) forming nucleated silica particles in the reaction vessel as a result of the step of adding reactive silica to the reaction vessel.

31. The method of claim 30, further comprising the step of:
(a) initially adding an aqueous solution to the reaction vessel prior to the step of adding reactive silica, the aqueous solution being substantially free of silica.

32. (canceled)

33. The method of claim 23, further comprising one or more of the following steps:
(a) quenching a reaction between one or more silicates and one or more ion exchange resins with a sufficient amount of water.

34. The method of claim 23, wherein the reactive period represents at least a 50% reduction in reaction time when compared to a method of forming silica particles in which the silica mass addition rate is constant and below 10.0 g/1000 m²-hr.

35. (canceled)

36. (canceled)

37. (canceled)

38. (canceled)

39. (canceled)

40. (canceled)

41. (canceled)

42. Colloidal silica particles formed by the method of claim 1.
